(19) United States
(12) Patent Application Publication
(10) Pub. No.: US 2023/0080997 A1
(43) Pub. Date: Mar. 16, 2023

(54) METHODS AND APPARATUS FOR PASTING ADVERTISEMENT TO VIDEO

(71) Applicant: Maycas Inventions Limited, Hong Kong (HK)

(72) Inventors: Pak Kit Lam, Hong Kong (HK); Cheng Yang, Auckland (NZ)

(21) Appl. No.: 17/946,552

(22) Filed: Sep. 16, 2022

Related U.S. Application Data
(63) Continuation of application No. PCT/CN2021/078595, filed on Mar. 2, 2021.
(60) Provisional application No. 62/991,498, filed on Mar. 18, 2020.

(51) Int. Cl. G06Q 30/02

(52) U.S. Cl. CPC G06Q 30/0276

(57) ABSTRACT

Disclosed herein are methods for pasting an object to a video. A method may include receiving the video having a plurality of video frames, in which an ending video frame is included; scanning a first video frame of the plurality of video frames, wherein the first video frame has one or more first target objects and one or more second target objects; determining whether a corresponding predetermined video frame information associated with the first video frame is identified in database; if so, segmenting the one or more second target objects; extracting the one or more segmented second target objects from the first video frame; pasting one or more predetermined objects to the one or more first target objects in the video frame, based on the predetermined video frame information associated with the first video frame; and pasting the extracted one or more second target objects to the video frame.

### CROSS REFERENCE TO RELATED APPLICATIONS

This application is a continuation application of PCT/CN2021/078595, filed on Mar. 2, 2021, which claims the benefit of U.S. Provisional Application No. 62/991,498 filed on Mar. 18, 2020. The contents of the above-mentioned applications are all hereby incorporated by reference.

### TECHNICAL FIELD

The present invention relates to pasting an object to a video, particular to system and method for pasting an advertisement to a video.

### BACKGROUND

It is known that one or more objects are allowed to be pasted to a video. The one or more objects may be advertising materials such as a 2D advertising banner/tag or a 2D advertising image. The 2D advertising banner/tag may occlude one or more objects in the video when pasting to the video. For example, the 2D advertising banner/tag occludes a performer in some scenes of the video, with the result that the video becomes unnatural and unreal. Audiences may be upset by such unnatural and unreal video and quit from viewing the video.

The present invention is directed to improvements that address foregoing issues and provide related advantages.

### SUMMARY OF INVENTION

Below various embodiments of the present invention are described to provide methods for pasting an advertisement to a video via a video advertisement platform.

Example methods are disclosed herein. An example includes apparatus has an AI engine to receive the video having a plurality of video frames, in which an ending video frame is included. A first video frame of the plurality of video frames is scanned, wherein the first video frame has one or more first target objects and one or more second target objects. The AI engine determines whether the first video frame of the plurality of video frames is the ending video frame, based on a video frame index. When the first video frame is not the ending video frame, the AI engine determines whether a corresponding predetermined video frame information associated with the first video frame is identified in database. When the corresponding predetermined video frame information associated with the first video frame is identified in database, the AI engine segments the one or more second target objects and extracts the one or more segmented second target objects from the first video frame. One or more predetermined objects are pasted to the one or more first target objects in the video frame, based on the corresponding predetermined video frame information associated with the first video frame. The extracted one or more second target objects are pasted to the video frame.

### BRIEF DESCRIPTION OF DRAWINGS

The present application can be best understood by reference to the figures described taken in conjunction with the accompanying drawing figures, in which like parts may be referred to by like numerals.

FIG. 1 illustrates a network configuration in accordance with various embodiments of the present invention.

FIG. 2 illustrates a block diagram of a video advertisement platform in accordance with various embodiments of the present invention.

FIG. 3A illustrates a login interface of a user interface of a video advertisement platform in accordance with various embodiments of the present invention.

FIG. 3B illustrates an upload video interface of a user interface of a video advertisement platform in accordance with various embodiments of the present invention.

FIG. 3C illustrates a video library interface of a user interface of a video advertisement platform in accordance with various embodiments of the present invention.

FIG. 3D illustrates a profile interface of a user interface of a video advertisement platform in accordance with various embodiments of the present invention.

FIG. 3E illustrates a create campaign interface of a user interface of a video advertisement platform in accordance with various embodiments of the present invention.

FIG. 3F illustrates a profile interface of a user interface of a video advertisement platform in accordance with various embodiments of the present invention.

FIGS. 4A-4D illustrate that one or more predetermined advertising materials and predetermined video frame information, associated with a video frame, are manually prepared in accordance with various embodiments of the present invention.

FIGS. 5A-5F illustrate that one or more second target objects are segmented and extracted from a video frame and one or more predetermined advertising materials are pasted to one or more first target objects by AI engine in accordance with various embodiments of the present invention.

FIG. 6 illustrates an example flow chart showing a process of pasting one or more advertising materials to a video frame in accordance with various embodiments of the present invention.

FIG. 7 illustrates another example flow chart showing a process of pasting one or more advertising materials to a video frame in accordance with various embodiments of the present invention.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present invention. Thus, the disclosed invention is not intended to be limited to the examples described herein and shown, but is to be accorded the scope consistent with the claims.

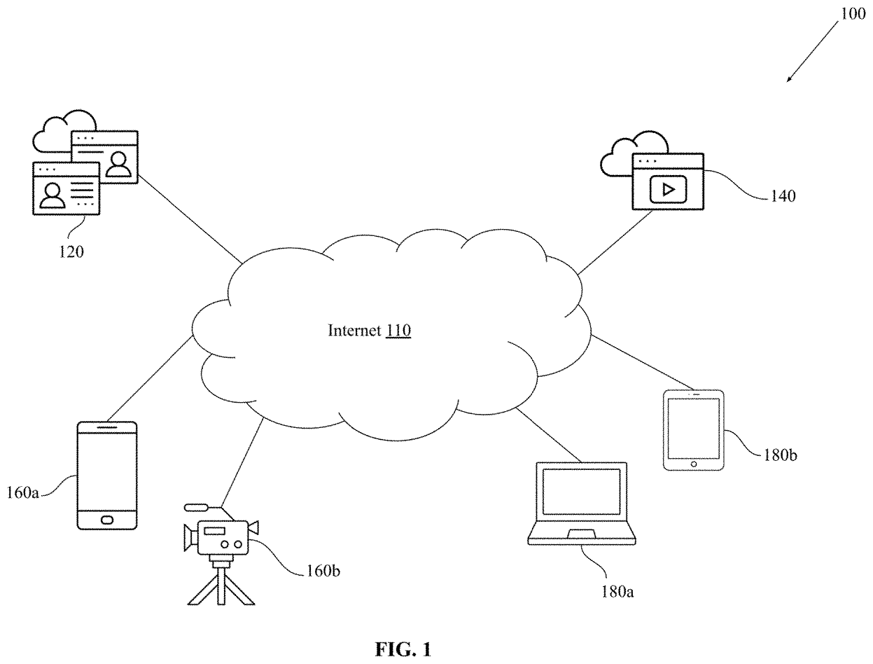

FIG. 1 illustrates a network configuration according to one of the embodiments of the present invention. Network 100 includes internet 110, video providers 160a and 160b, service subscribers 180a and 180b, video sharing platform/social media platform 140 and video advertisement platform 120. Video providers include but not limited to movie producers, TV producers, influencers, artists, celebrities, key opinion leaders (KOLs), individuals and agencies. Service subscribers 180a and 180b include but not limited to advertisers, advertising agencies, brand owners, service providers and product manufacturers. Video sharing platform and/or social media platform 140 includes but not limited to Youtube®, Vimeo®, Tiktok®, Youku®, Bilibili®, Tencent Video®, Facebook®, Instagram®, Twitter® and Weibo®. In one embodiment, first service subscriber 180a is an advertiser who is allowed to upload one or more objects to video advertisement platform 120. The one or more objects are stored in database. The one or more objects may be advertising materials or any images. The advertising material may be a 2D or 3D image, which includes a brand logo, a product, a poster, a banner, a slogan, a statement or any images for promotion/marketing.

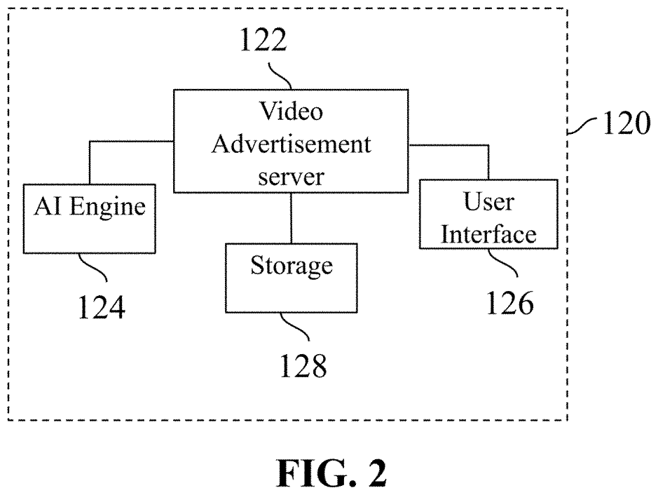

FIG. 2 illustrates a simplified view of block diagram of video advertisement platform 120 according to one of the embodiments of the present invention. Video advertisement platform 120 includes video advertisement server 122 at which artificial intelligence (AI) engine 124, user interface 126 and storage 128 are included.

In one embodiment, one or more video providers is/are registered user(s) of video advertisement platform 120. The one or more video providers use a video filming device, such as a smartphone, a tablet computer, a handheld computer, a camcorder, a video recorder, a camera or any device having video filming function, to make videos. Merely by way of example, first video providers 160a uses his/her smartphone to film one or more videos. Second video provider 160b uses a video recorder to film one or more videos. First video provider 160a and second video provider 160b are registered users and are allowed to upload one or more videos to video advertisement server 122. Both of first video provider 160a and second video provider 160b are influencers. Each of first video provider 160a and second video provider 160b has his/her own login name for example his/her email address. There is no limitation on the format of the login name. The login name may be any combination of letters and numbers. Each of first video provider 160a and second video provider 160b has his/her own login password.

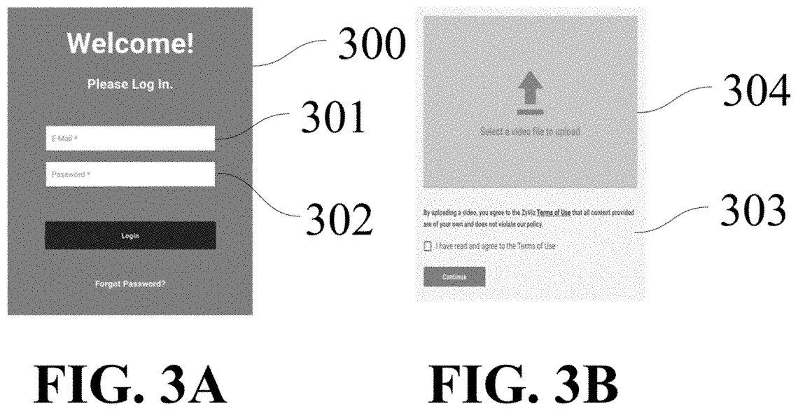

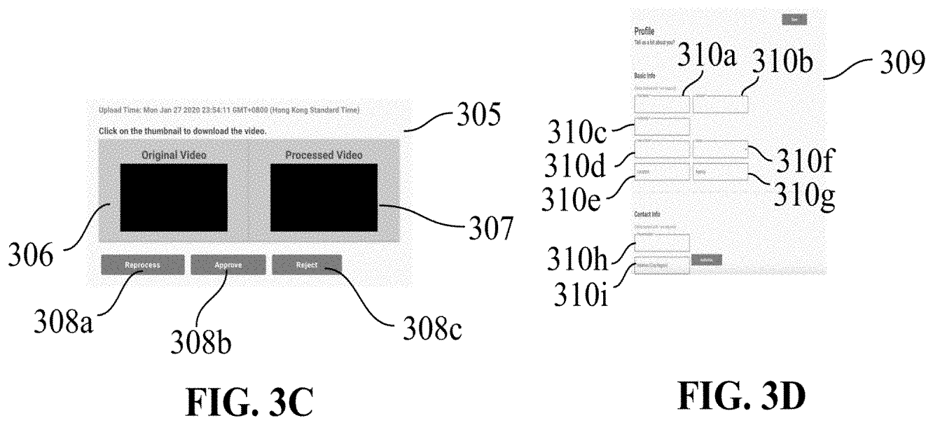

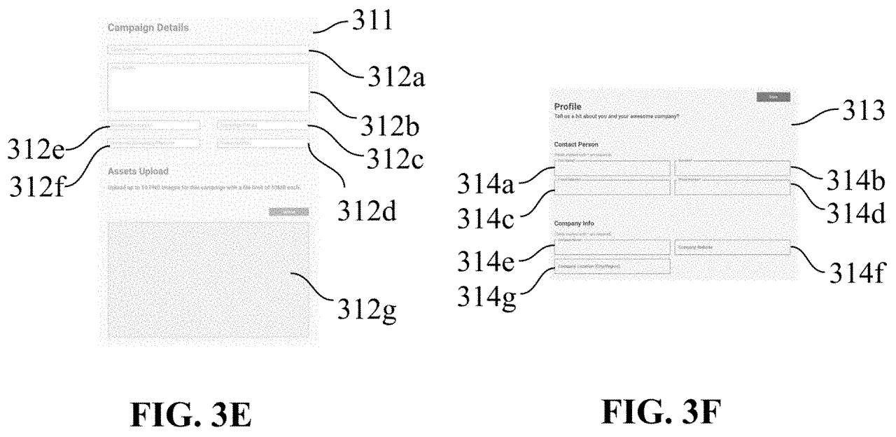

FIG. 3A illustrates a login interface of a user interface of a video advertisement platform in accordance with various embodiments of the present invention. Login interface 300 is configured for a user to access video advertisement platform 200. In one example, Login interface 300 may be a browser-based version and run on a web browser. The web browser may run on a variety of operating systems, including a personal computer operating system, such as Windows, iOS or Linux, or a mobile operating system, such as iOS, Android, or Windows Mobile, or the like. In another example, Login interface 300 may be an app version which run on a variety of operating systems.

Merely by way of example, Login interface 300 includes login name field 301 and login password field 302. First video provider 160a is allowed to enter his/her login names in login name field 301. First video provider 160a is then allowed to enter his/her login password in login password field 302.

Once first video provider 160a enters login name and login password successfully, first video provider 160a is allowed to access upload video interface 303 as illustrated in FIG. 3B. Upload video interface 303 is dedicated for video provider 160a to upload one or more videos.

Upload video interface 303 includes box 304 for video provider 160a to open a video file (which is also named as an original video) to be uploaded. The original video is then arranged to be uploaded to video advertisement server 122 and to be stored in storage 128.

Once the original video is uploaded to the video advertisement server 122 successfully, the original video will be displayed on video library interface 305 as illustrated in FIG. 3C. Video library interface 305 is dedicated for the video provider to operate. The original video is then arranged to be processed by AI engine 124 by inserting one or more advertising materials. Merely by way of example, the original video is included in original video display box 306. When the one or more advertising materials are pasted to the original video successfully, a corresponding processed video will be generated. The processed video will be included on processed video display box 307. Video library interface 305 further includes reprocess button 308a, approve button 308b and reject button 308c. First video provider 160a is allowed to review the processed video. First video provider 160a is then allowed to reprocess, approve or reject the processed video by pressing corresponding button (reprocess button 308a, approve button 308b and reject button 308c) after reviewing the processed video. The original video is downloadable by first video provider 160a via original video display box 306. Also, the processed video is downloadable by first video provider 160a via processed video display box 306.

Merely by way of example, first video provider 160a is allowed to update his/her profile information at profile interface 309 as illustrated in FIG. 3D. Profile interface 309 is dedicated for a video provider to use. Profile interface 309 includes one or more profile information fields for the video provider to enter. For example, Profile interface 309 may include first name field 310a, surname field 310b, nationality field 310c, year of birth field 310d, location field 310e, gender 310f, agency field 310g, phone number field 310h and address field 310i. There is no limitation on what profile information fields are included in profile interface 309. For one example, profile information fields may further include education field, social media account field and employment history field. For another example, profile information fields may include first name field 310a, surname field 310b, nationality field 310c, year of birth field 310d only. First video provider 160a is allowed to enter information in the corresponding field.

FIG. 3E illustrates a create campaign interface of a user interface of a video advertisement platform in accordance with various embodiments of the present invention. In one embodiment, first service subscriber 180a is an advertiser and is also a registered user of video advertisement platform 120. First service subscriber 180a has a login name and a login password. First service subscriber 180a opens login interface 300 on a web browser. When first service subscriber 180a enter the login name in login name field 301 and the login password in login password field 302 successfully, first service subscriber 180a is allowed to access create campaign interface 311.

Create campaign interface 310 includes campaign name field 312a, description 312b, campaign period field 312c, referred KOL field 312d, broadcast location field 312e and preferred video streaming platform 312f. There is no limitation on what fields are included in create campaign interface 311. For one example, create campaign interface 311 may further include category field (for example sport, fitness, music, lifestyle, food, technology and travel) and/or preferred language field. For another example, create campaign interface 311 may include campaign name field 312a and description 312b only. First service subscriber 180a is allowed to enter information in the corresponding field. In addition, create-campaign interface 311 provides a field or a box for first service subscriber 180a to upload one or more objects. First service subscriber 180a is allowed to upload one or more advertising materials via assets upload box 312g.

Merely by way of example, first service subscriber 180a is allowed to update profile information via profile interface 313 as illustrated in FIG. 3F. Profile interface 313 is dedicated for a service subscriber to use. Profile interface 313 may include one or more profile information fields for the service subscriber to enter. For example, profile interface 313 may include two sections which are contact person section and company information section. First name field 314a, surname field 314b, email address field 314c and phone number field 314d are included in the contact person section. There is no limitation on what fields are included in the contact person section. For example, the contact person section may further include instant messaging account (for example Wechat®, Whatsapp®, Messenger®, Skype® and Line®). The company information section may include company name field 314e, company website field 314f and company location field 314g. There is no limitation on what fields are included in the company information section. For example, the company information section may further include company address field and business nature field. First service subscriber 180a is allowed to enter information in the corresponding field.

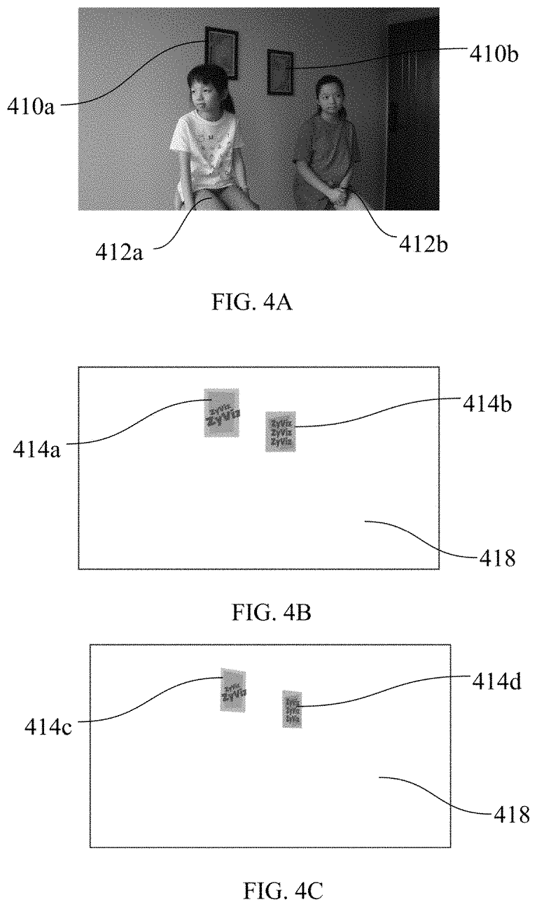

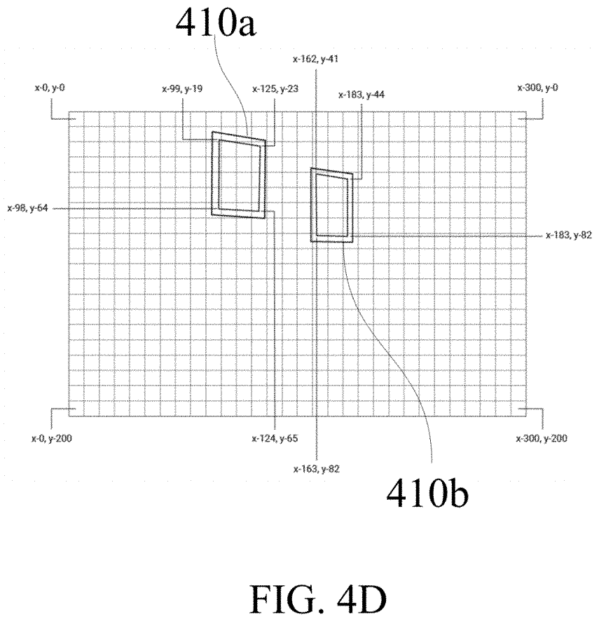

FIG. 4A-4D illustrate that one or more predetermined advertising materials and predetermined video frame information, associated with a video frame, are manually prepared in accordance with various embodiments of the present invention. In one embodiment, video advertisement platform 120 receives a first video from first video provider 160a. The first video is displayed on original video display box 306. The first video may satisfy one or more predetermined requirements such as resolution, duration, existence of target objects, filming background and filming stability).

The first video includes a plurality of video frames. Before the first video is scanned by AI engine 124, the plurality of video frames is arranged to be examined manually in order to identity one or more first target objects. For example, the first target object may be a quadrilateral object such as a picture frame, a monitor, a display or a television. There is no limitation on the shape of the first target object. The first target object may be a triangular, hexagonal, or octagonal objects. There is no limitation on the nature of the first target object. The first target object may be a table, a cabinet, a wall, a bed or any objects with plain surfaces.

The video frames may be manually examined one by one or may be manually examined in collective manner. For example, the first video includes N video frames, with a video frame index n (n is from 0 to N−1). A beginning video frame of N video frames has the video frame index equal to 0 (n=0) and an ending video frame of N video frames has the video frame index equal to N−1 (n=N−1).

In one embodiment, the video frames are manually examined one by one. When one or more first target objects are identified in the examined video frame, location(s) and shape(s) of the one or more first target objects is/are annotated, which will be considered as predetermined video frame information associated with the examined video frame and stored in database in storage 128.

One or more objects provided by service subscribers will be selected and retrieved from the database. The selection of the one or more objects may be automatically made by AI engine 124, based on content of the first video or may be manually made.

In one example, one or more objects provided by a service subscriber are one or more advertising materials, which are arranged to be retrieved and displayed on the examined video frame, based on the location(s) of one or more first target objects. In one example, the one or more objects is manually reshaped and aligned with the one or more identified first target objects. The one or more reshaped objects lie on a transparent plain surface.

The one or more reshaped objects together with the transparent plain surface are associated with the examined video frame and are stored in storage 128 as one or more predetermined objects associated with the examined video frame. The location(s) and the shape(s) of the one or more objects is/are the same as the location(s) and shape(s) of the one or more annotated first target objects. The same procedure will be applied to other video frames to be examined, in which one or more first target objects are identified.

In one embodiment, as illustrated in FIG. 4A, the first video has 10000 video frames, one of which is manually examined. For example, the video frame with n=1000 (a first video frame) is manually examined. Two first target objects 410a and 410b are identified in the video frame with n=1000. Two second target objects are in front of two first target objects 410a and 410b respectively. For example, second target object is human being. Second target objects 412a and 412b are in front of first target objects 410a and 410b respectively. Second target object 412a partially occludes first target object 410a.

Locations and shapes of first target objects 410a and 410b are annotated respectively. The locations and shapes of first target objects 410a and 410b will be considered as predetermined video frame information associated with the video frame with n=1000 and stored in the database.

One or more objects provided by service subscribers will be selected and retrieved from the database. In one example, two advertising materials 414a and 414b provided by first service subscriber 180a are arranged to be retrieved and displayed on the video frame with n=1000, based on the locations of first target objects 410a and 410b as illustrated FIG. 4B. Two advertising materials 414a and 414b lie on transparent plain surface 418.

Two advertising materials 414a and 414b are manually reshaped and aligned with two identified first target objects 410a and 410b to became two reshaped advertising materials 414c and 414d as illustrated in FIG. 4C. Two reshaped advertising materials 414c and 414d lie on transparent plain surface 418.

Two reshaped advertising materials 414c and 414d are associated with the video frame with n=1000 and are stored in storage 128 as one or more predetermined advertising materials associated with video frame with n=1000. The locations and the shapes of advertising materials 414c and 414d are the same as the locations and shapes of first target objects 410a and 410b. The same procedure will be applied to other video frames to be examined, in which one or more first target objects are identified.

Alternatively, two first target objects 410a and 410b are identified in the video frame with n=1000. The video frame with n=1000 is considered as a plain surface with x axis and y axis. For example, the x axis is from 0 to K and the y axis is from 0 to L. The value of K and the value of L depends on the resolution of the first target object. If the resolution is 720×480, the x axis is from 0 to 720 and the y axis is from 0 to 480. As illustrated in FIG. 4D, first target object 410a and 410b have four corners respectively. Location information for four corners of both first target object 410a and 410b are manually annotated. For example, the location information for four corners are coordinates. First set of coordinates of first target object 410a are manually annotated as (99,19), (125,23) (98,64) and (124,65). First set of coordinates of first target object 410b are (162,41), (183,44) (163,82) and (183,82). The first set of coordinates will be considered as predetermined video frame information associated with the video frame with n=1000 and stored in the database. Advertising materials 514a and 514b are arranged to past to first target objects 410a and 410b respectively, based on the first set of coordinates of first target objects 410a and 410b and advertising materials 514a and 514b are stored in storage 128 as one or more predetermined advertising materials associated with video frame with n=1000. The same procedure will be implemented in other video frames to be examined, in which one or more first target objects are identified.

In one embodiment, the video frames are manually examined in collective manner. One or more first target objects appears in full duration of the first video or one or more first target objects appears and disappears throughout the first video. The first video includes N video frames (such as N=10000), with video frame index from n=0 to n=9999 and has a full duration of 400 seconds.

In one embodiment, one or more first target objects appears in full duration of the first video. One or more first target objects have may different location(s) and shape(s) throughout the first video. For example, for video frame with n=0 to video frame with n=3000 (first batch), one or more first target objects having first location(s) and first shape(s) throughout video frame with n=0 to video frame with n=3000 are identified. For example, video frame with n=1000 is manually examined.

The first locations and first shapes of one or more first target objects are annotated, which will be considered as predetermined video frame information associated with video frames with n=1000. The first locations and first shapes of one or more first target objects will be associated with video frames of from video frame with n=0 to video frame with n=3000 to form predetermined video frame information associated with corresponding video frame.

One or more advertising materials is arranged to appear in video frame n=1000, based on the first location(s) of one or more first target objects. The one or more advertising materials are manually reshaped and aligned with the one or more first target objects. The one or more reshaped advertising materials lie on a transparent plain surface.

The one or more reshaped advertising materials together with the transparent plain surface are associated with video frame with n=10000 and are stored in storage 128 as one or more predetermined advertising materials associated with video frame with n=10000.

The one or more reshaped advertising materials together with the transparent plain surface will be associated with video frames included from video frame with n=0 to video frame with n=3000 to form one or more predetermined advertising materials associated with corresponding video frame.

For video frame with n=3001 to video frame with n=6000 (second batch), one or more first target objects having second location(s) and second shape(s) throughout video frame with n=3001 to video frame with n=6000 are identified. For example, video frame with n=4000 is manually examined. The same process above will be implemented in from video frame with n=3001 to video frame with n=6000.

For video frame with n=6001 to video frame with n=9999 (third batch), one or more first target objects having third location(s) and third shape(s) throughout video frame with n=6001 to video frame with n=9999 are identified. For example, video frame with n=7000 is manually examined. The same process above will be implemented in from video frame with n=6001 to video frame with n=9999.

In another embodiment, one or more first target objects appears and disappears throughout the first video. For example, one or more first target objects with first location(s) and first shape(s) are identified throughout video frame with n=0 to video frame with n=3000 (first batch). Also, one or more first target objects with second location(s) and second shape(s) are identified throughout video frame with n=6001 to video frame with n=9999 (second batch). No first target objects are identified throughout video frame with n=3001 to video frame with n=6000.

For video frame with n=0 to video frame with n=3000, video frame with n=1000 is manually examined. The first locations and first shapes of one or more first target objects are annotated, which will be considered as predetermined video frame information associated with video n=1000. The first locations and first shapes of one or more first target objects are associated with video frames of from video frame with n=0 to video frame with n=3000 to form predetermined video frame information associated with corresponding video frame.

One or more advertising materials are arranged to appear in video frame n=1000, based on the first location(s) of one or more first target objects. The one or more advertising materials are manually reshaped and aligned with the one or more first target objects. The one or more reshaped advertising materials lie on a transparent plain surface.

The one or more reshaped advertising materials together with the transparent plain surface are associated with the examined video frame and are stored in storage 128 as one or more predetermined advertising materials associated with video frame with n=1000. The one or more reshaped advertising materials together with the transparent plain surface will be associated with video frames of from video frame n=0 to video frame n=3000 to form one or more predetermined advertising materials associated with corresponding video frame.

For video frame with n=6001 to video frame with n=9999 (second batch), video frame with n=7000 is manually examined. The same process above will be implemented in from video frame with n=6001 to video frame with n=9999. For video frame with n=3001 to video frame with n=6000, no action will be performed.

In one embodiment, the video frames are manually examined in collective manner, based on coordinates of one or more first target objects. For example, one or more first target objects are identified in video frame with n=0 to video frame with n=3000 (first batch), coordinates of the one or more first target objects remains the same from video frame with n=0 to video frame with n=3000. Taking example of video frame with n=1000 being manually examined. Coordinates of four corners of one or more first target objects are manually annotated. For instance, first set of coordinates of first target object 410a are manually annotated as (99,19), (125,23) (98,64) and (124,65). First set of coordinates of first target object 410b are (162,41), (183,44) (163,82) and (183,82). The first set of coordinates of first target objects 410a and 410b will be considered as predetermined video frame information associated with the video frame with n=1000.

The first set of coordinates of first target objects 410a and 410b will be considered as predetermined video frame information associated with the video frame with n=1000 and stored in the database. Predetermined video frame information of each of video frames from n=0 to n=3000 will be updated with first set of coordinates of first target objects 410a and 410b.

For other batches having one or more of first target objects, the same process above will be implemented.

Once the manual examination on the first video completes successfully, the first video will be scanned by AI engine 124. The AI engine 124 will scan from the beginning video frame to the ending video frame of the plurality of video frames of the first video one by one. The first video includes N video frames, with the video frame index n (n is from 0 to N−1). The beginning video frame of N video frames has the video frame index equal to 0 and an ending video frame of N video frames has the video frame index equal to N−1. For example, the first video includes 10000 video frames and the video frame index n is from 0 to 9999.

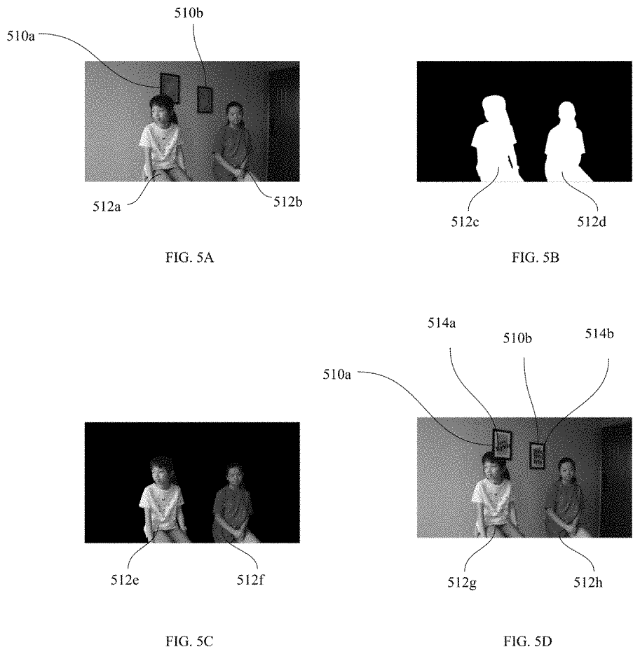

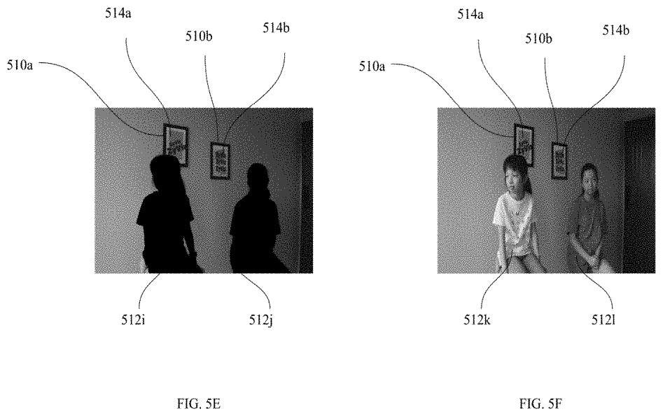

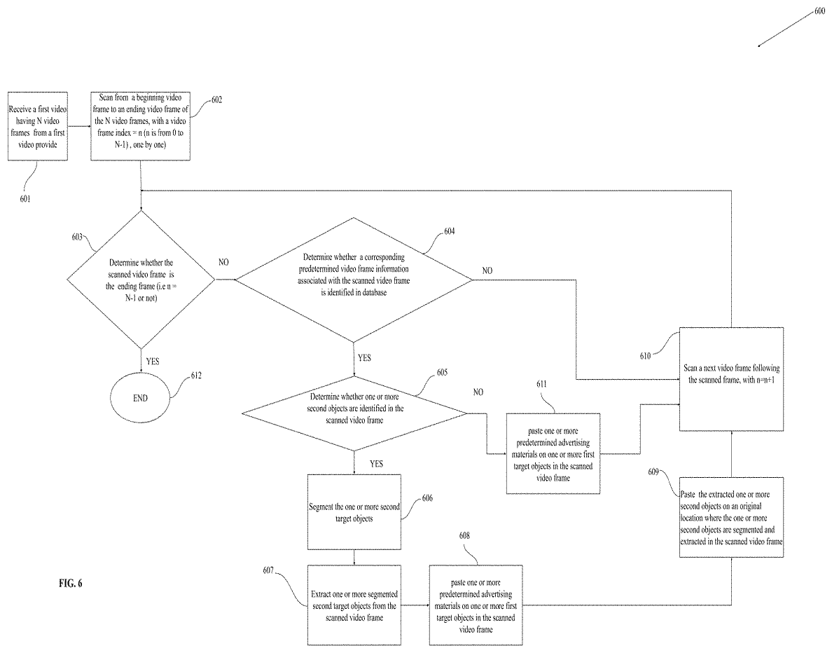

Merely by way of example, the video frame with n=1000 is scanned by AI engine 124 as illustrated in FIG. 5A. AI engine 124 will determine whether n is equal to N−1 (equal to 9999) or not. If n is not equal to N−1 (i.e., 9999), AI engine 124 will determine whether the video frame with n=1000 is included one or more first target objects by cross checking corresponding predetermined video frame information with the video frame with n=1000 stored in the database.

If the predetermined video frame information associated with the video frame with n=1000 is identified in the database, predetermined advertising materials 414c and 414d associated with the video frame with n=1000 will retrieved from the database.

AI engine 124 will automatically perform segmentation and extraction when one or more second target objects are identified in the scanned video frame (video frame with n=1000). For example, second target object is a human being. Two second target objects 512a and 512b are identified in the video frame with n=1000 by AI engine 124. AI engine 124 will perform segmentation on two second target objects 512a and 512b to obtain segmented second target objects 512c and 512d. AI engine 124 will then perform extraction to obtain target objects 512e and 512f from the video frame with n=1000.

Predetermined advertising materials 514a and 514b are arranged to be pasted to first target objects 510a and 510b (which is named as an AD pasted video frame with n=1000) by inserting transparent plain surface 418, based on the predetermined video frame information associated video frame with n=1000. Two second target objects 512e and 512f are pasted to the original location (where two second target objects are segmented and extracted) in the AD pasted video frame with n=1000 to form a processed video frame with n=1000.

AI engine 124 is configured to scan a next video frame and the video frame index is incremented by 1 (n=n+1). The same procedure will be implemented in upcoming video frames. When AI engine finishes scanning all video frames of the first video, advertising materials 414c and 414d are pasted to the first video. The first video will become a processed video and will be shown on processed video display box 307.

In one embodiment, for segmentation, AI engine 124 processes the first video by using a deep neural network. AI engine 124 is configured to collect pixels of second target objects 512a and 512b (both are human beings). Different deep neural networks may be used such as Mask RCNN, RVOS and Deeplabv3+. For example, Mask RCNN is used for segmentation. A core network in the Mask RCNN is the “restnet101” which includes 100 convolutional layers. The core network is pretrained by COCO dataset for segmenting 1000 different objects. For example, segmentation is configured to apply on human being. Thus, human being images are selected from the COCO dataset. Therefore, a total of 6000 human being images are selected, 5000 of which are used for training and 1000 of which are used for validation. Mask RCNN is retrained again by using these 6000 images. After the training, the deep neural network is configured to segment second target objects 512a and 512b. As illustrated in FIG. 5B, in the video frame with n=1000, masked human beings 512c and 512d (with pixels “1”, first pixel value) represents the segmentation of second target objects 512a and 512b. Objects behind second target objects 512c and 512d are represented with pixels “0”, second pixel value. After the segmentation, AI engine 124 will extract segmented second target objects 512e and 512f (which are colorful) from the video frame with n=1000, based on masked human beings 512c and 512d, as illustrated in FIG. 5C.

Masked second target object 512c and 512d are used to obtain human being pixels from the video frame with n=1000. For example, the video frame with n=1000 is a 3-dimensional (3D) matrix F. The 1^{st} (F₁) and 2^{nd} (F₂) dimensions represent the height and width of the video frame with n=1000 respectively. The 3^{rd} dimension (F₃) represents color channels. Let F₃ (0) denote the red channel (R), F₃ (1) denote the green channel (G) and F₃ (2) denote the blue channel (B).

Masked human beings 512c and 512d are represented by a single-channel matrix M. The height and width of Matrix M are identical to those of Matrix F. Human being pixels (for both second target object 512a and 512b) on Matrix F are extracted by using Matrix M. An output of a human being image (H) is obtained. The human being image (H) also includes 3 color channels (RGB). The extraction follows the formula below:

H(0)=F₃(0)·M

H(1)=F₃(1)·M

H(2)=F₃(2)·M

In the formulas above, the multiple sign “·” represents multiplication of each element (pixel) between two Matrix F and Matrix M. The masked image pixel values are “1” and the unmasked pixel values are “0”. Pixel values of Matrix F multiply “1” to get the original values and pixel values of Matrix F multiply “0” to get “0”. Therefore, the human being image (H) displays the colorful second target objects 512e and 512f and black background as illustrated in FIG. 5C.

In one example, in order to mitigate the unwanted occlusion, second target objects 512i and 512j are extracted from Matrix P as illustrated in FIG. 5E.

B(0)=P₃(0)·(1−M)

B(1)=P₃(1)·(1−M)

B(2)=P₃(2)·(1−M)

B represents a background image, which displays on the background of predetermined advertising materials 514a and 514b pasted video frame image (P). Masked second target object 512c and 512d will become black in this background image. The (1−M) operation reverses the pixel value for masked second target object 512c and 512d and becomes 512i and 512j as shown in FIG. 5E.

Second target objects 512k and 512l (i.e. the human being image represented by H) and the background (i.e. the background image presented by B) are then merged to get the final result video frame (R):

R=H+B

The formula above adds each corresponding element (pixel) from H and B. The R is the processed video frame with n=1000, shown in FIG. 5F, including predetermined advertising materials 514a and 514b pasted on to first target objects 510a and 510b respectively. One of the benefits of using segmentation and extraction of one or more second target objects is that one or more advertising materials are pasted to the first video in a subtle manner and the first video looks like natural without any unwanted scene caused by the one or more advertising materials occluding the one or more second target objects.

In another example, as illustrated in FIG. 5D, predetermined advertising materials 514a and 514b are arranged to be pasted to first target objects 510a and 510b in the video frame with n=1000 respectively in order to obtain another Matrix P. Matrix P is similar to Matrix F, except that it now contains advertising materials 514a and 514b and predetermined advertising material 514a occludes second target object 512g, which is unnatural and unpleasant to viewers. second target objects 512e and 512f of FIG. 5C are pasted to FIG. 5D to obtain FIG. 5F in order to mitigate the unwanted occlusion between advertising material 514a and second target object 512g. As illustrated in FIG. 5F, predetermined advertising material 514a and 514b are pasted to first target objects 510a and 510b in the video frame with n=1000. Second target objects 512k and 512l are in front of first target objects 510a and 510b in the video frame with n=1000 without any occlusion.

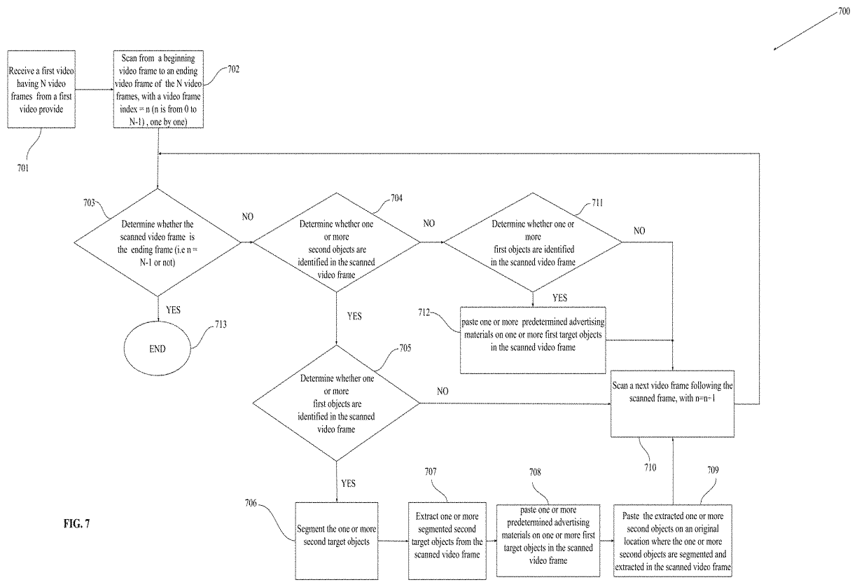

Turning now to FIG. 6, an example process 600 for pasting one or more advertising materials to one or more first target objects in a scanned video frame. In some examples, process 600 is implemented at computing apparatus such as video advertisement server 122. As shown in FIG. 6, process 600 is implemented at includes receiving a first video having a plurality of video frames from a first video provider 160a at Step 601 by video advertisement server 122. The plurality of video frames has N video frames, in which a beginning video frame and an ending video frame are included. The N video frames are scanned in video advertisement server 122 from the beginning video frame to the ending video frame one by one at Step 602. Each of the N video frames is assigned with a video frame index n (n is from 0 to N−1). The beginning video frame of N video frames has the video frame index equal to 0 (n=0) and the ending video frame of N video frames has the video frame index equal to N−1 (n=N−1). At Step 603, AI engine 124 will determine whether a scanned video frame (a first video frame) is the ending frame (i.e. n=N−1 or not). If the scanned video frame is not the ending video frame (n≠N−1), AI engine 124 will then determine whether a corresponding predetermined video frame information associated with the scanned video frame is identified in database at Step 604. If the corresponding predetermined video frame information associated with the scanned video frame is identified in database, AI engine 124 will determine whether one or more second targets are identified in the scanned video frame by a second trained deep neural network at Step 605 If the one or more second targets (second objects 512a and 512b) are identified in the scanned video frame, AI engine 124 will segment one or more second target objects for example second target objects 512c and 512d at Step 606. AI engine 124 will then extract segmented second target objects 512c and 512d at Step 607. AI engine 124 will then paste predetermined advertising materials to one or more first target objects (for example, first target objects 510a and 510b), based on the corresponding predetermined video frame information associated with the scanned video frame at Step 608. At Step 609, AI engine 124 will paste extracted second target objects 512e and 512f to an original location where second target objects 512a and 512b in the scanned video frame. At Step 610, AI engine will then scan a next video frame following the scanned frame, with n=n+1.

At Step 604, if the corresponding predetermined video frame information associated with the scanned video frame is not identified in database, Step 610 will be performed.

At Step 605, if the one or more second targets are not identified in the scanned video frame, Step 611 will be performed. Step 611 is the same as Step 608

At Step 603, if the scanned video frame is the ending video frame (n=N−1), Step 612 will be performed by ending the scanning process.

Turning to FIG. 7, another example process 700 implemented at computing apparatus such as video advertisement server 122. As shown in FIG. 7, Step 701, Step 702 and Step 703 are the same as Step 601, Step 602 and Step 603 respectively. At Step 704, AI engine 124 will determine whether one or more second targets are identified in the scanned video frame by a second trained deep neural network. If one or more second targets (second objects 512a and 512b) are identified in the scanned video frame, AI engine 124 will determine whether one or more first targets are identified in the scanned video frame by a first trained deep neural network at Step 705. If one or more first targets (first target objects 150a and 150b) are identified in the scanned video frame, Step 706 will be performed. Step 706 is the same as 606. Step 707, Step 708, Step 709 and Step 710 are the same as Step 607, Step 608, Step 609 and Step 610 respectively.

At Step 704, If one or more second targets are not identified in the scanned video frame, AI engine 124 will determine whether one or more first targets are identified in the scanned video frame by the first trained deep neural network at Step 711. If one or more first targets (first target objects 150a and 150b) are identified in the scanned video frame, Step 712 will be performed and then Step 710 will be performed. Step 712 is the same as Step 708.

At Step 711, if one or more first targets are not identified in the scanned video frame, Step 710 will be performed.

At Step 703, if the scanned video frame is the ending video frame (n=N−1), Step 713 will be performed by ending the scanning process.

The disclosed and other embodiments, modules and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for pasting one or more predetermined object to a video frame of a video with an artificial intelligence (AI) engine, comprising:
receiving the video having a plurality of video frames, in which an ending video frame is included;
scanning a first video frame of the plurality of video frames, wherein the first video frame has one or more first target objects and one or more second target objects;
determining whether the first video frame of the plurality of video frames is the ending video frame, based on a video frame index;
if the first video frame is not the ending video frame, determining whether a corresponding predetermined video frame information associated with the first video frame is identified in database;
if the corresponding predetermined video frame information associated with the first video frame is identified in database, segmenting the one or more second target objects;
extracting the one or more segmented second target objects from the first video frame;
pasting one or more predetermined objects to the one or more first target objects in the video frame, based on the corresponding predetermined video frame information associated with the first video frame; and
pasting the extracted one or more second target objects to the video frame.

2. The method of claim 1, wherein the corresponding video predetermined video frame information is manually determined and stored in the database.

3. The method of claim 1, further comprising: masking the one or more second target objects with first pixel value and objects behind the one or more second target objects with second pixel value in the first video frame.

4. The method of claim 1, wherein the one or more predetermined objects are advertising materials.

5. The method of claim 1, wherein the one or more second target objects are located in front of the one or more first target objects and partially occlude the one or more first target objects in the first video frame.
